(19) United States
(12) Patent Application Publication
(10) Pub. No.: US 2006/0161862 A1
(43) Pub. Date: Jul. 20, 2006

(54) Enabling users to create and use a directory of document links from within a file menu of an application

(75) Inventors: Dean Anthony Racovolis, Redmond, WA (US); Douglas J. Turner, Kirkland, WA (US)

Correspondence Address: Daniel P. McLoughlin;Wolf, Greenfield & Sacks, P.C., 600 Atlantic Avenue, Boston, MA, 02210-2206, US

(73) Assignee: Microsoft Corporation, Redmond, WA (US)

(21) Appl. No.: 11/039,292

(22) Filed: Jan. 20, 2005

(51) Int. Cl. G06F 9/00

(52) U.S. Cl. 715/804

(57) ABSTRACT

Enabling a user to link to documents through the file menu of an application, including linking to documents of types other then those supported by the application. A user may be provided access, through a file menu of an application, to a link directory of links, at least one of the links linking to a document of a type not supported by the application. In response to the user selecting a link to a document of a type not supported by the application, focus may be transferred to another application that does support the type of document. If the document was not already open, an opening of the document may be initialized, and if the other application was not already running, a launch of the other application may be controlled. A user may be enabled to create, organize and/or refresh a display of a link directory.

### BACKGROUND

A variety of types of software applications are available today to help people create, organize, manage and process information, whether for personal or work-related use. Such applications include word-processing applications (e.g., Microsoft® Word), spreadsheet applications (e.g. Microsoft® Excel™), database applications (e.g., Microsoft® Access), presentation applications (e.g., PowerPoint®), publishing applications (e.g., Microsoft® Publisher), photo viewing and/or editing applications, document viewing applications (e.g. Adobe® Reader®), email applications, calendar applications, task management applications, other types of applications, and any suitable combination of the foregoing (e.g., Microsoft Outlook®), to name just a few. Software vendors often package two or more applications together as a suite of applications such as, for example, the several versions of the Microsoft® Office suite of applications available from Microsoft Corporation. Software applications typically are configured to work with files of one or more particular types, the file type typically indicated by the extension to the file name (e.g., .doc, .xls, .pdf, .ppt, etc.).

For a personal or work-related project, users often employ multiple documents and/or applications. Further, these documents may be shared between multiple individuals. For example, for a work-related project (e.g., a product's development), several team members may utilize a spreadsheet application to create multiple spreadsheets, a word-processing application to produce several text documents and a presentation application to create presentations related to the project. Similarly, a husband and wife may endeavor upon a home improvement project involving the creation and use of several shared documents using different applications.

Throughout a project, a user typically has two or more “favorite” documents on which the user frequently works. If the documents are of different type (e.g., a Microsoft® Word document and a Microsoft® Excel™ document), the user must go back and forth between the applications that support the documents. To do so, typically a user must minimize the current application in which the user is working and/or select from outside of the current application window (e.g., by selecting an icon on the user's screen), another application. Further, if a particular document is not currently open, the user must select it be first locating it, for example, by navigating a file directory external to the current application.

Jumping back and forth between applications and locating documents is time consuming, and can become tedious. As a result, mechanisms have been developed that make it easier for users to go back and forth between applications. For example, links (e.g., hyperlinks) to other documents or other documents themselves may be embedded in a document. However, this technique impacts the content of the document itself, which typically is not desired. Another technique, which can be used in Microsoft® Word and other applications of a Microsoft® Office suite of applications, is to utilize the functionality provided by the Favorites menu of Microsoft® Internet Explorer, for example, as shown FIG. 1.

FIG. 1 is a screenshot illustrating an example of a graphical user interface (GUI) display 100 of Microsoft® Word that includes web toolbar 102, including Favorites menu 104. Through Favorites menu 104, a user can link to documents listed in the Favorites directory 105, including documents of a type not supported by Word (e.g., Microsoft® Excel™ and Microsoft® Internet Explorer). Further, a user can add, to the Favorites directory, a link to the current document on which the user is working.

Applicant has observed, however, that users typically do not use the Favorites menu 104 from within Microsoft® Word to link to other documents. For one, using the Favorites menu within Word is not intuitive, as users typically associate the Favorites menu with navigating web sites on the Internet, not with opening documents. Further, many users do not know how to add the Favorites menu 104 to the Word interface display, or even that it is possible to do so. Moreover, even if a user does know, the user may not be willing to take the extra time to add web toolbar 102 to the interface display. Another shortcoming of using the Favorites menu 104 to link to documents is that, because the Favorites menu is derived from Microsoft® Internet Explorer, the menu displays the Internet Explorer icon for all links (e.g., links 106), regardless of the type of document to which a link links. Further, the menu does not display file extensions for the documents. Thus, a user cannot tell the type of document linked to by each link, which is another reason that using the Favorites menu to link between documents is not intuitive.

### SUMMARY

Applicant has recognized the need for a more intuitive and convenient way for users to link to documents from within an application, in particular, to link to documents of a type other than the type(s) supported by the application. Further, Applicant has observed that users typically associate accessing documents and other file operations with the file menu of an application, for example, through the File item 101 of the Word menu bar or a shortcut (e.g., open file shortcut 103) on the standard Word toolbar.

Described herein are systems and methods for enabling a user to link to documents through the file menu of an application, including linking to documents of types other then those supported by the application.

In some embodiments, a user is provided access, through a file menu of an application (e.g., an application of a Microsoft® Office suite of applications), to a link directory of a plurality of links, at least one of the links linking to a document of a type not supported by the application. In some embodiments, in response to the user selecting a link to a document of a type not supported by the application, focus is transferred to another application that does support the type of document. If the document was not already open, an opening of the document may be initialized, and if the other application was not already running, a launch of the other application may be controlled.

In some embodiments, users may be enabled (e.g., through the file menu of an application) to create and/or organize a link directory, and to refresh a display of the link directory. As used herein, a “link” is a software abstraction (e.g., an object or file) that has a name (or other identifier) and holds a value indicating the name and location of another software abstraction such as, for example, a file for a document. Thus, a link points to, and serves as a link to, a document. As used herein, a “link directory” is a logical hierarchy defining an organization of links to documents (e.g., stored as files). A link directory includes at least a first level and may include one or more other levels. The first level of a link directory (e.g., first level 305 in FIGS. 3 and 5) may include one or more links (e.g., link 322 in FIGS. 3 and 5) and/or one or more sub-directory folders (folders 318 and 320 in FIGS. 3-5). The contents of a sub-directory folder of the first level (i.e., the sub-directory itself) may be considered a second level of the directory. For example, links 324 and 326 shown in sub-directory menu 310 of FIG. 3 may be considered a second level of the directory having first level 305. Each sub-directory (at any level in the link directory) may be considered a link directory itself, and may include one or more links and/or one or more sub-directory folders.

It should be appreciated that the documents to which links of link directory link may all reside on a same device on a network or one or more documents may reside on different devices. Further, the device on which a linked-to document resides may be the same device being used by a user (e.g., the user's workstation, personal computer, laptop of other user device) to access the link directory. It should further be appreciated that the link directory itself may reside on a same or different network device from one or more documents to which the link directory links. For example, a network may include, among other things, a web server, a file server, and a user's personal computer. The link directory and one or more documents to which it links may reside on the user's personal computer (e.g., on the user's hard drive), one or more other document to which it links may reside on the web server, and one or more documents to which it links may reside on the file server. The foregoing is just one example of the physical arrangement on a network of a link directory and the documents to which it links, and is not intended to be limiting. Other arrangements are possible and are intended to fall within the scope of the invention.

In an embodiment of the invention, a system is provided for providing a user access, from within a first application, to one or more documents not supported by the first application. The system includes a user interface to provide a user, from within a file menu of the first application, access to a link directory including a plurality of user-selectable links. Each link links to a respective document, at least one of the plurality of links linking to a first document of a first type not supported by the first application. The system also includes a link execution module to transfer focus, in response to a user selecting the first document, to a second application that supports documents of the first type, to provide access to the first document.

In an aspect of this embodiment, the link execution module is operative to control a launch of the second application in response to the user selecting the first document.

In another aspect of this embodiment, the link execution module is operative to initiate an opening of the first document by the second application.

In yet another aspect of this embodiment, the user interface includes means for providing access to the link directory from within the file menu of the first application.

In another aspect of this embodiment, the link execution module includes means for transferring focus to the second application.

In another aspect of this embodiment, the first application is member of a Microsoft® Office suite of applications.

In yet another aspect of this embodiment, the user interface is operative to control a display, within the file menu, of a menu item for the link directory, wherein the menu item is selectable by a user.

In another aspect of this embodiment, the menu item is labeled “Shortcuts”.

In another aspect of this embodiment, the user interface is operative to enable a user, through the file menu, to control creation of a link in the link directory.

In yet another aspect of this embodiment, at least two of the links link to two documents, respectively, of different type, such that the user interface provides a user access to the at least two documents of different type.

In another aspect of this embodiment, the user interface is operative to display, for each link in the directory of links, an icon representing a type of the document to which the link links, including displaying at least two different icons corresponding to the at least two links.

In another aspect of this embodiment, the system further includes an icon determination module to determine, for each link of the link directory, an icon that represents a type of the document to which the link links.

In yet another aspect of this embodiment, the system further includes another user interface to provide access, from within a file menu of a third application of different type than the first application, to the link directory.

In another embodiment of the invention, a user is provided access, from within a first application, to one or more types of documents not supported by the first application. From within a file menu of the first application, the user is provided access to a link directory including a plurality of user-selectable links. Each link links to a respective document, at least one of the plurality of links linking to a first document of a first type not supported by the first application. In response to the user selecting the first document, focus is transferred to a second application that supports documents of the first type, to provide the user access to the first document.

In an aspect of this embodiment, a launch of the second application is controlled.

In another aspect of this embodiment, an opening of the first document by the second application is initiated.

In another aspect of this embodiment, the first application is member of a Microsoft® Office suite of applications.

In yet another aspect of this embodiment, a menu item for the link directory is displayed within the file menu, where the menu item is selectable by a user.

In another aspect of this embodiment, a user is enabled to control, through the file menu, creation of a link in the link directory.

In another aspect of this embodiment, at least two of the links link to two documents, respectively, of different type, such that providing the user access to the link directory includes providing access to the at least two documents of different type.

In yet another aspect of this embodiment, providing the user access to the link directory includes displaying, for each link in the directory of links, an icon representing a type of the document to which the link links, including displaying at least two distinct icons corresponding to the at least two links.

In another aspect of this embodiment, for each link of the link directory, an icon is determined that represents a type of the document to which the link links.

In another aspect of this embodiment, the user is provided access, from within a file menu of a third application of different type than the first application, to the link directory.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs.

In yet another embodiment of the invention, provided is a system for providing a user access, from within a first application, to a links menu for performing operations associated with a link directory including a plurality of user-selectable links, each link linking to a respective document. The system includes a user interface to display a file menu for the first application. The file menu includes a plurality of user-selectable menu items, including a links menu item providing a user access to the links menu for performing operations associated with the link directory.

In an aspect of the invention, the user interface includes means for including, in the file menu, a links menu item providing a user access to the links menu for performing operations associated with the link directory.

In another aspect of this embodiment, the user interface is operative to display the links menu in response to a user selecting the links menu item.

In another aspect of this embodiment, the links menu includes at least one folder of the link directory, and the user interface is operative to display a sub-directory of the link directory in response to a user selecting the at least one folder.

In yet another aspect of this embodiment, the links menu includes an add links menu item, and the user interface is operative, in response to a user selecting the add links menu item, to display an add links window to the user through which the user may add one or more links to the link directory.

In another aspect of this embodiment, the links menu includes an organize links menu item, and the user interface is operative, in response to a user selecting the organize links menu item, to display an organize links window to the user through which the user may organize the link directory.

In another embodiment of the invention, a user is provided access, from within a first application, to a links menu for performing operations associated with a link directory including a plurality of user-selectable links, each link linking to a respective document. A file menu for the first application is displayed. The file menu includes a plurality of user-selectable menu items, including a links menu item providing a user access to the links menu for performing operations associated with the link directory.

In an aspect of this embodiment, the links menu is displayed in response to a user selecting the links menu item.

In another aspect of this embodiment, the links menu includes at least one folder of the link directory, and the a sub-directory of the link directory is displayed in response to a user selecting the at least one folder.

In another aspect of this embodiment, the links menu includes an add links menu item, and, in response to a user selecting the add links menu item, an add links window is displayed to the user through which the user may add one or more links to the link directory.

In yet another aspect of this embodiment, the links menu includes an organize links menu item, and, in response to a user selecting the organize links menu item, an organize links window is displayed to the user through which the user may organize the link directory.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a screen shot illustrating an example of a GUI display of an application that includes a Favorites menu;

FIG. 2 is a block diagram illustrating an example of a system for providing a user access, from within an application, to a link directory of links to documents;

FIG. 3 is a screen shot illustrating an example of the portion of a user interface display proving a user access, from within a file menu of an application, to a link directory;

FIG. 4 is a screen shot illustrating an example of a user interface display for adding a link to a link directory;

FIG. 5 is a screen shot illustrating an example of the user interface display for organizing links of a link directory;

FIG. 6 is a block diagram illustrating an example of a system for providing user's access, from within a plurality of applications, to a link directory including a plurality of links to respective documents;

FIG. 7 is a flowchart illustrating an example of a method of providing a user access, from within a first application, to a link directory including a plurality of links to respective documents;

FIG. 8 is a flowchart illustrating an example of a method of enabling users through a file menu of one or more applications, to create, modify and access a link directory;

FIG. 9 is a flowchart illustrating an example of a method for executing a link of a link directory;

FIG. 10 is a block diagram illustrating an example of a computer system on which some embodiments of the invention may be implemented; and

FIG. 11 is a block diagram illustrating an example of a storage system that may be used as part of the computer system to implement some embodiments of the invention.

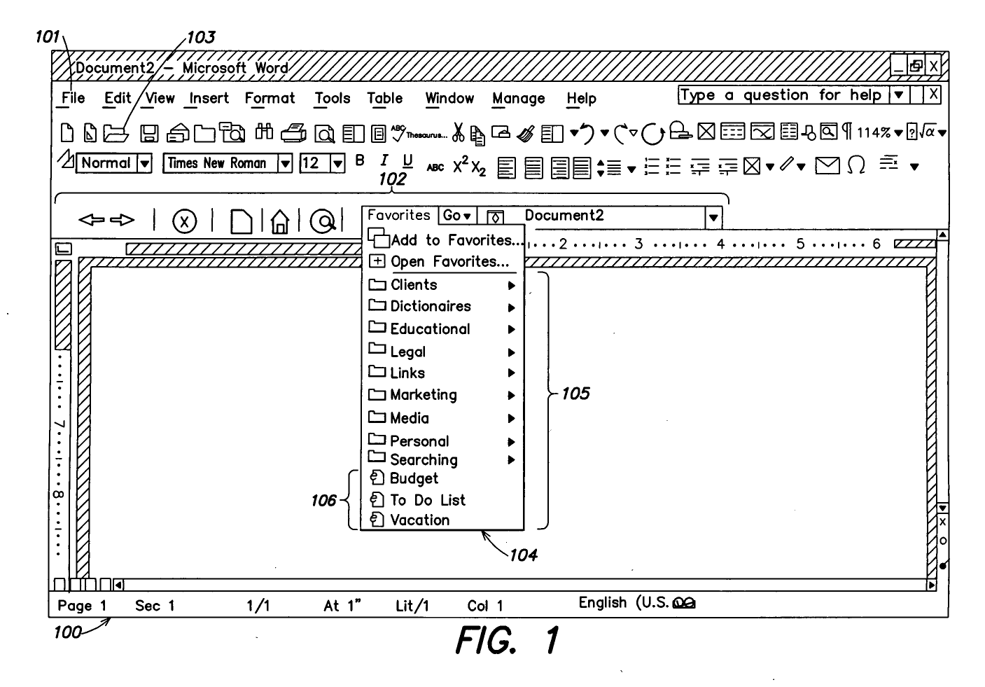

### DETAILED DESCRIPTION

Described herein are examples of systems and methods for enabling a user to link to documents through the file menu of an application, including linking to documents of a type other then those supported by the application. Although these systems and methods are described primarily in relation to providing access to document links through a file menu, the invention is not so limited. In various embodiments of the invention, access to document links may be provided in other ways, in addition to or as an alternative to the file menu. For example, access may be provided through one or more other menus, one or more tool bars, one or more shortcut icons, one or more other visual controls or any suitable combination of the foregoing, each of which may be provided by a user interface of an application.

As used herein, a “user interface” is an application or part of an application (i.e., a set of computer-readable instructions) that enables a user to interface with an application during execution of the application. A user interface may include code defining how an application outputs information to a user during execution of the application, for example, visually through a computer screen or other means, audibly through a speaker of other means, and manually through a game controller or other means. Such user interface also may include code defining how a user may input information during execution of the application, for example, audibly using a microphone or manually using a keyboard, mouse, game controller, track ball, touch screen or other means.

The user interface may define how information is visually presented (i.e., displayed) to the user, and defines how the user can navigate the visual presentation (i.e., display) of information and-input information in the context of the visual presentation. During execution of the application, the user interface may control the visual presentation of information and enable the user to navigate the visual presentation and enter information in the context of the visual presentation. Types of user interfaces range from command-driven interfaces, where users type commands, menu-driven interfaces, where users select information from menus, and combinations thereof, to GUIs, which typically take more advantage of a computer's graphics capabilities, are more flexible, intuitive and easy to navigate and have a more appealing “look-and-feel” than command-driven and menu-driven visual user interfaces. As used herein, the visual presentation of information presented by a user interface or GUI is referred to as a “user interface display” or a “GUI display”, respectively.

Although several embodiments described herein are described in relation to applications of the Microsoft® Office suite of applications, it should be appreciated that the invention is not so limited. Embodiments of the invention may be implemented using other applications and other types of applications.

The function and advantage of these and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

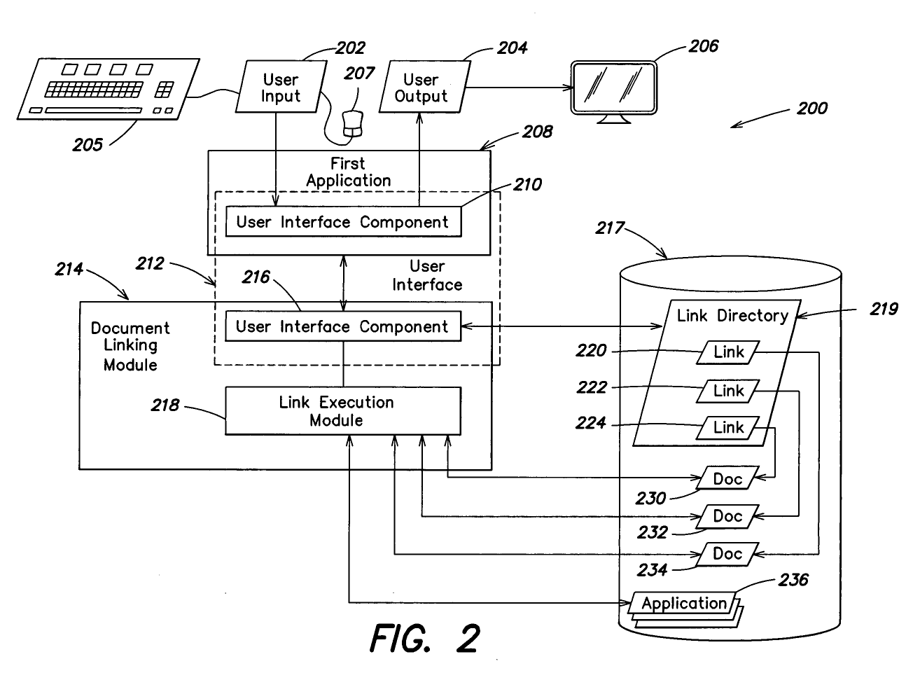

FIG. 2 is a block diagram illustrating an example of a system 200 for providing a user access, from within an application, to a link directory 219 of links to documents. System 200 is merely an illustrative embodiment of a system for providing a user access, from within an application, to a link directory, and is not intended to limit the scope of the invention. Any of numerous other implementations of such a system, for example, variations of system 200, are possible and are intended to fall within the scope of the invention.

System 200 may include any of first application 208, user interface 212, document linking module 214, user display device 206, one or more data sources 216, one or more user input devices (e.g., keyboard 205, mouse 207 and/or any of those described above) and one or more user output devices (e.g., display device 206 and/or any of those described above).

First application 208 may be an of a variety of applications and types of applications such as, for example, any of the applications and types of applications described herein. First application 208 may include a user interface component 210 that enables the first application to interface with a user during execution of the first application. Component 210 may exchange information with user devices, including receiving user input from user input devices such as, for example, keyboard 205 and mouse 207, and sending information to user output devices such as, for example, display device 206.

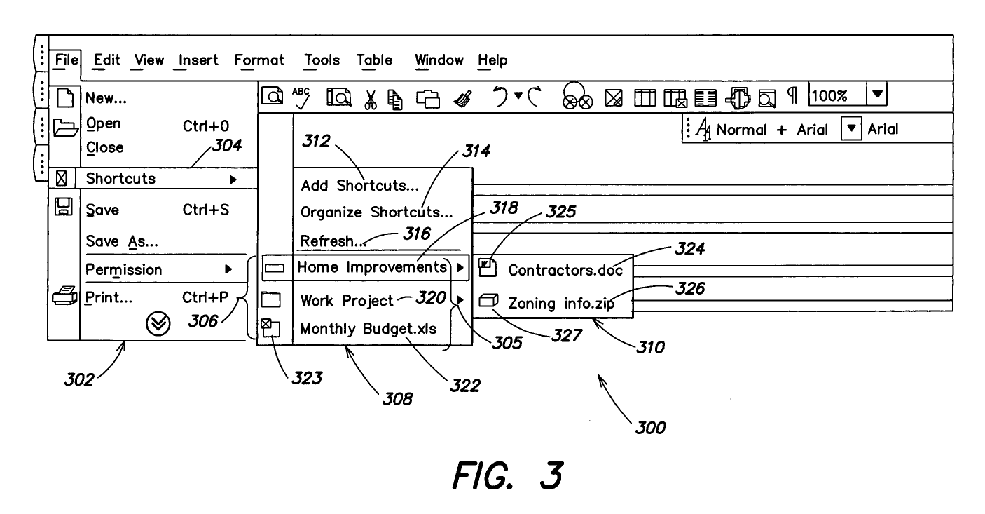

Document linking module 214 may include a user interface component 216 and/or a link execution module 218. User interface component 216 may be configured to interact with user interface component 210 of the first application, such that these components together form a user interface 212 that interfaces with a user of the first application. User interface component 216 may be configured such that user interface 212 provides access for users, through a file menu of the first application, to link directory 219 stored in one or more data sources 217. For example, user interface 212 may provide one or more user interface displays to assist a user in accessing link directory 218, such as, for example, any of user interface displays 300, 400 and 500, described below in relation to FIGS. 3-5. In some embodiments, user interface 212 and/or user interface 612 (described below) may be configured (e.g., programmed) to provide user interface displays 300, 400 and/or 500 similar in appearance to user interface displays provided by Internet Explorer. As used herein, an “application programming interface” or “API” is a set of one or more computer-readable instructions that provide access to one or more other sets of computer-readable instructions that define functions, so that such functions can be configured to be executed on a computer in conjunction with an application program. An API may be considered the “glue” between application programs and a particular computer environment or platform (e.g., any of those discussed below) and may enable a programmer to program applications to run on one or more particular computer platforms or in one or more particular computer environments.

Link directory 218 may include a plurality of links, including links 220, 222, and 224 to documents 230, 232 and 234, respectively. Link directory 218 may include a plurality of levels (not shown), and each of links 220, 222 and 224 may be included in any of these levels. The hierarchical structure of the link directory, including the locations of links and folders within the directory may be controlled by one or more users. For example, one or more users may create links within the link directory and organize the link directory, including naming, moving and deleting links within the directory, as is described below in more detail. The link directory 218 may be stored on a non-volatile recording medium, for example, a disk, and may be located within a file directory provided by the operating system on which system 200 is implemented (e.g., on the “C” drive of one of operating systems available from Microsoft Corporation. For example, a link directory for a user John Smith may be located at: “C:/Documents and Settings/jsmith/”.

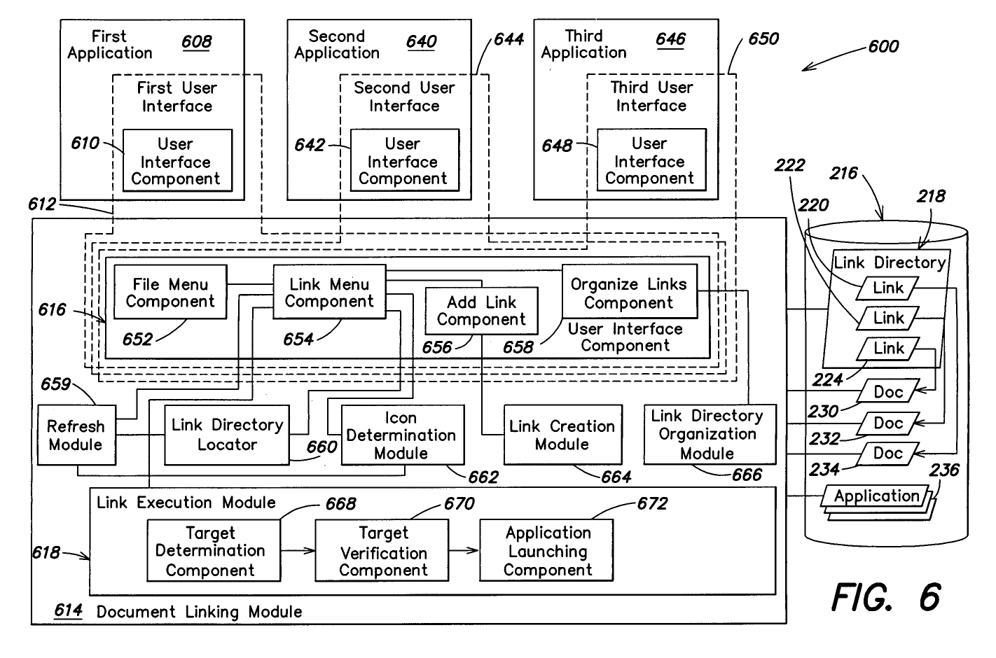

Link execution module 218 may be configured to execute a link to a document in response to a user selecting a link from link directory 219. For example, in response to a user selecting link 220 from link directory 219, link execution module 218 may execute a link to document 230. To execute a link, link execution module 218 may be configured to determine the location of a document (e.g., file) specified by a link and verify that the document still exists at the location. Link execution module 218 also may be configured to: open the document linked to a selected link if it is not already opened; transfer focus to a second application that supports the type of document if the first application 208 does not support the type; and control a launch of the second application if necessary. A more detailed embodiments of a link execution module is described below in more detail in relation to FIGS. 6-9.

Most of today's operating systems, including those available from Microsoft Corporation, provide the capability of running multiple processes (e.g., threads) concurrently. These processes may include processes running as part of executing multiple applications concurrently. Such operating systems arbitrate (e.g., based on user input and other information) the application that is currently in focus for the user. Typically, if an application is in focus, its application window is active such that it is visually presented in the foreground of a GUI display, in front of the other application windows, with a cursor or other indicator residing in the active window. That is, the application that is in focus is the application in which the user is currently working. As used herein, to “transfer focus” from a first application to a second application means to change the application in which the user is currently working from the first application to the second application, which may include making active the application window of the second application and placing a cursor or other indicator in the newly active window.

For example, a user may currently have open several Microsoft® Excel™, Word and PowerPoint® documents. Current focus may be on Word if the user is working on a Word document. If the user selects one of the Excel™ documents (e.g., by clicking on its icon in the task bar provided on the GUI display), focus is transferred to Excel™. Thus, the window for Excel™ may be made active, such that it overlays the window for Word.

First application 208 may be configured to call document linking module 214, for example, when first application 208 is launched. In some embodiments, system 200 may be implemented using an operating system (e.g., one of the operating systems available from Microsoft Corporation listed below) that provides a registry to persist information (e.g., configuration and/or customization information) for the operating system and applications running on an operating system. The persisted information may include “add-ins” to applications, where an “add-in” is an object or file that specifies customizations and/or additions to an application. An add-in may be registered for an application in the registry. The registry may be stored in non-volatile memory (e.g., on a disk) and may be accessed by an operating system and/or application, in particular, when the operating system and/or application, respectively, is launched.

Accordingly, in embodiments where the operating system provides a registry (or similar construct) an add-in for the document linking module 214 may be registered in the registry for the first application 208. In response to the first application being launched, the registry entry specifying the document linking module 214 may be accessed and the first application may be configured to interact with the document linking module 214, which may produce, for example, the user interface 212. In some embodiments, the document linking module 214 may be implemented as a dynamic link library (DLL), and a reference to this DLL may be stored in a registry location corresponding to the first application 208.

FIG. 3 is a screen shot illustrating an example of a portion of a user interface display 300 providing a user access, from within a file menu of an application, to a link directory. Display 300 is merely an illustrative embodiment of a user interface display providing a user, from within a file menu of an application, access to a link directory, and is not intended to limit the scope of the invention. Any of numerous other implementations of such a display, for example, variations of display 300, are possible and are intended to fall within the scope of the invention. User interface display 300 may be generated by user interfaces 212 and/or 612 described in relation to FIGS. 2 and 6, respectively.

Display 300 may include file menu 302, link menu 308 and link sub-directory menu 310. The display of sub-directory menu 310 may result from a user selecting (e.g., clicking on with a mouse or making keyboard entries) link 318 (labeled “Home Improvements”) from link menu 308, which may have been displayed as a result of a user selecting links item 304 (labeled “Shortcuts”) of file menu 302.

File menu may include a plurality of menu items, including links item 304, labeled “Shortcuts”. It should be appreciated that the link menu item may include a different label. In some embodiments of the invention (e.g., when the first application 208 is an application of the Microsoft® Office suite of applications such as, for example, Word), the display of the links item 304 may be controlled by user interface component 216 or 616 of the document linking module 214 or 614, respectively, and the remaining file menu items may be controlled by user interface component 210 of the first application 208. The file menu 302 may be configured such that, if a user selects links item 304, link menu 308 is displayed.

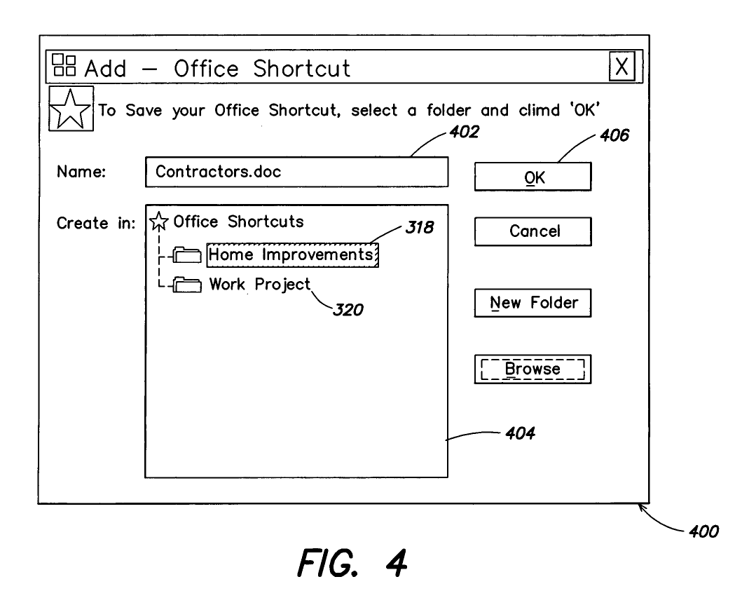

Link menu 308 may include any of add link item 312, organize links item 314, refresh item 316 and link directory component 306. Selection of add link item 312 may enable a user to add a link to a link directory, for example, by opening user interface display 400 described below in more detail in relation to FIG. 4.

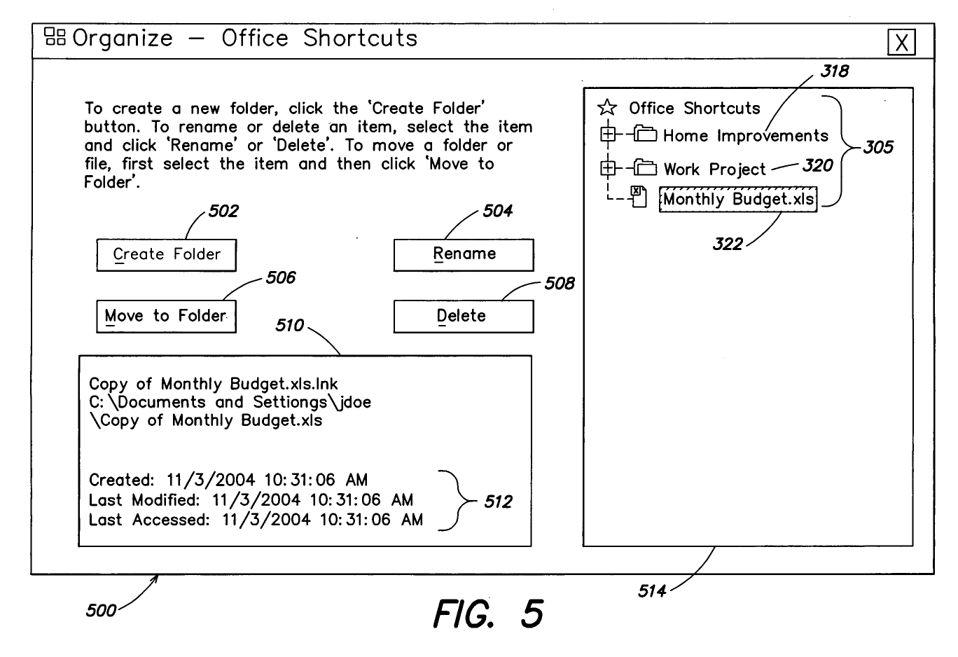

Organize links item 314 may be configured to enable a user to organize links of a link directory in response to being selected, for example, by opening user interface display 500 described below in more detail in relation to FIG. 5.

Refresh item 316 may be configured to enable a user to refresh the display of link directory component 306 and any subsequent displays of sub-directories thereof such as, for example, in sub-directory menu 310. As described below in relation to FIG. 6, a plurality of applications (e.g., those of the Microsoft® Office suite of applications) may share a same link directory. Accordingly, the link directory may have been changed by another application (e.g., by the user of the current application or another user) since the last update of the link directory display. By clicking the refresh icon 316, a user can update the display of the link directory component 306 and any subsequent displays of link sub-directories to reflect any changes since the last refreshing (e.g., since the launch of the current application or the last time the links item 304 was selected).

Link directory component 306 shows the contents of the first level 305 of a link directory, including sub-directories 318 (“Home Improvements”) and 320 (“Work Project”) and link 322 (“Monthly Budget.xls”). As indicated by icon 323, link 322 links to a Microsoft® Excel™ document. In response to a user selecting link 322, the link execution module 212 or 612 may transfer focus from the current application to Microsoft® Excel™, as will be described in more detail below.

Each of sub-directories 318 and 320 may be configured to display a sub-directory menu for its respective sub-directory in response to be being selected. For example, as shown in FIG. 3, in response to link 318 being selected, sub-directory menu 310 is displayed.

A sub-directory menu may display links of a sub-directory and icons corresponding to the document types of respective links. For example, sub-directory menu 310 includes item 324 (“Contractors.doc”) and item 326 (“Zoning info.zip), next to respective icons 325 and 327. As indicated by icon 325, link 324 is to a Microsoft® Word document and link 326 is to a WinZip document. In response to a user selecting link 324, link execution module 212 or 612 may be configured to transfer focus to Microsoft® Word, unless the current application is Microsoft® Word. Similarly, if item 326 is selected, focus may be transferred to WinZip. As will be described in more detail below, in addition to transferring focus to another application, a link execution module may be configured to launch the other application and/or open the document corresponding to the link if not already opened.

FIG. 4 is a screen shot illustrating an example of a user interface display 400 for adding a link to a link directory. Display 400 is an illustrative embodiment of a user interface display for adding a link to a link directory, and is not intended to limit the scope of the invention. Any of numerous other implementations of such a display, for example, variations of display 400, are possible and are intended to fall within the scope of the invention.

Display 400 may include a text box 402 enabling a user to enter a name for a link, and a window 404 enabling a user to select a location within a directory to place the link. In the example illustrated in FIG. 4, a user is adding the link “Contractor.doc” to the link folder “Home Improvements” of a first level of a directory.

FIG. 5 is a screen shot illustrating an example of the user interface display 500 for organizing links of a link directory. Display 500 is merely an illustrative embodiment of a user interface display for organizing links of a link directory, and is not intended to limit the scope of the invention. Any of numerous other implementations of such a display, for example, variations of display 500, are possible and are intended to fall within the scope of the invention.

Display 500 may include any of create folder control 502, rename control 504, move to folder control 506, delete control 508, information window 510 and selection window 514. Selection window 514 may be configured to initially display the first level of a directory, which, in this case, are folders 318 and 320 and link 322. If any of the folders are selected, window 514 may display the contents (e.g., folders and links) of the sub-directory represented by the folder. Selection window 514 enables a user to select a link or folder of the directory being displayed. For example, link 322 is selected in the example illustrated in FIG. 5.

A selected link may be renamed, deleted or moved to another folder using controls 504, 508 or 506, respectively. Further, the information corresponding to a selected folder or link from window 312 may be displayed in information window 510. In the example of FIG. 5, the name of link 322 is displayed along with a location of the file of the document to which it links. Also displayed in window 510 in the example of FIG. 5 is log information 512 regarding when the link was created, last modified and last accessed.

FIG. 6 is a block diagram illustrating an example of a system for providing users access, from within a plurality of applications, to a link directory of links to respective documents. System 600 is merely an illustrative embodiment of a system for providing users access, from within an application, to a link directory of links to respective documents, and is not intended to limit the scope of the invention. Any of numerous other implementations of such a system, for example, variations of system 600, are possible and are intended to fall within the scope of the invention.

System 600 may include first application 608 (e.g., first application 208 of system 200), second application 640, third application 646, user interfaces 612 (e.g., user interface 212 of system 200), 644 and 650, document linking module 614 and one or more data sources 216. In some embodiments of the invention, multiple applications (e.g., applications 608, 640 and 646) share a common link directory 218 and interface with a common document linking module 614 (e.g., document linking module 214 of system 200). Accordingly, user interface component 616 (e.g., user interface component 216 of system 200) of document linking module 614 may interact with user interface components 610, 642 and 648 to implement user interfaces 612, 644 and 646, respectively.

Document linking module 614 may include any of: user interface component 616, refresh module 659, link directory locator 660, icon determination module 662, link creation module 664, link directory organization module 666, link execution module 618 and other components. User interface component 616 may include any of: file menu component 652, link menu component 654, add link component 656, organized links component 658 and other components.

File menu component 652 may be configured to interact with the user interface components of applications 608, 640 and/or 646 to provide users of these applications the ability to link to link directory 218. For example, file menu component 652 may control a file menu of an application such as, for example, file menu 302 of user interface display 300, to display a links item such as, for example, links item 304. Some applications such as Microsoft® Word require a template to draw items on a menu such as the file menu. For example, by default, Word uses the “Normal.dot” template, and this template may be customized to include a links menu item. However, in some embodiments, file menu component 652 may be configured to create a distinct, custom template (e.g., a Customization Context) that utilizes features of the Normal.dot template and also adds link item 304. File menu component 652 also may be configured to call link menu component 654 in response to a user selecting the links item from the file menu.

Link menu component 654 may be configured to display a link menu such as, for example, link menu 308 of display 300. To display the link directory component 306 of menu 308, link menu component 654 may be configured to call link directory locator 660 to determine the location of link directory 218. As described above, link directory 218 may be stored within a folder (e.g., “C:/Documents and Settings/jsmith/”) in the file directory of the operating system. Link directory locator 660 may be configured to determine the location of this folder. For example, if the operating system is one of the operating systems available for Microsoft Corporation (described below), link directory locator 660 may use the Win32 API to locate the folder of the link directory, for example, by invoking the SHGetSpecialFolderLocation function of the Win32 API.

The link menu component 654 also may be configured to call the icon determination module 662 to determine the icons associated with each link. Icon determination module 662 may be configured to determine the type of the document to which each link links and determine an icon associated with the document type. For example, if system 600 is implemented using one of the operating systems available from Microsoft Corporation described below, icon determination module 662 may be configured to use the Win32 API. For example, module 662 may be configured to invoke the SHGetFileInfo function of Win32 API.

It should be appreciated that in some embodiments, link directory locator 660 and icon determination module 662 are called each time an application configured to provide access to the link directory is launched, and the information for displaying the link directory is stored in local memory. Subsequently, in response to the links item 304 being selected and the link menu 308 being displayed, the locally stored link directory information can be retrieved.

With the information determined by link directory locator 660 and icon determination module 662, link menu component 654 may be configured to display the contents of link directory 218, including the icons associated with each link. For example, link menu component 654 may be configured to display the contents of a first level of a directory in link menu 308 and, in response to selection of a folder in link menu 308, the contents of a sub-directory in sub-directory menu 310.

Link menu component 654 may be configured to call refresh module 659 in response to a user requesting that the link directory display be refreshed, for example, by selecting refresh item 316 from link menu 308. Refresh module 659 may be configured to refresh the link directory display as described in relation to refresh item 316 of FIG. 3, and may be configured to interact with link directory locator 660 and icon determination module 662 to perform the refresh.

Link menu component 654 may be configured to call add link component 656 in response to a user selecting add link item 312 from link menu 308. Add link component 656 may be configured to display user interface display 400 in response to the selection of add link item 312. In response to a user entering a name in text box 402 and selecting okay control 406, add link component 656 may be configured to create a link within link directory 218 by calling link creation module 664. Link creation module 664 may be configured to create a link using any of a variety of techniques. For example, if system 600 is implemented using one of the Microsoft operating systems described below, link creation module 664 may use the Shell Link Object of the Windows Shell to create a new link.

In response to a user selecting organized links item 314 from link menu 308, link menu component 654 may call organize links component 658. Component 658 may be configured to provide user interface display 500 for organizing links. To perform any of the functions provided by controls 502, 504, 506 and 508, organized links component 616 may call links directory organization module 666. To create folders, rename folders, delete folders and move folders to other folders, module 666 may use the file system object provided by the operating system (e.g., one of the operating systems available from Microsoft Corporation). To rename a link, delete a link or move a link to a folder, link directory organization module may use an object provided by the operating system. For example, if system 600 is implemented using one of the Microsoft operating systems described below, module 666 may be configured to use the Shell Link Object to perform the user-selected function.

In response to a user selecting a link (e.g., link 322, 324 or 326) link menu component 654 may call link execution module 618. Module 618 may include a target determination component 668, a target verification component 670 and an application launching component 672.

Target determination component 668 may determine the name and location of the document to which the selected link points. If system 600 is implemented using one of the operating systems described below available from Microsoft, component 668 may use the Shell Link Object to determine the name and location of the document to which the link points.

Target verification component 670 may be configured to determine whether the named document still exists at the determined location. It may be desirable to perform verification because the document may have been deleted or moved since the link to the document was created such that the link is no longer valid. Verification component 670 may use the file system object provided by the operating system to determine whether the determined document still exists at the determined location.

Application launching component may be configured to launch an application that supports the type of document to which the link points in the event that the current application does not support this type of document. For example, if the current application is Microsoft® Word and the document corresponding to the link is a Microsoft® Excel™ document, application launching component 672 may launch Microsoft® Excel™ to open the link-to document. In embodiments where system 600 is implemented using one of the Microsoft operating systems described below, application launching component 672 may use the Win32 API to launch the application. For example, component 672 may invoke the ShellExecute function of the Win32 API.

System 200 and/or system 600, and components thereof may be implemented using software (e.g., C, C#, C++, Java, or a combination thereof), hardware (e.g., one or more application-specific integrated circuits), firmware (e.g., electrically-programmed memory) or any combination thereof. One or more of the components of system 200 and/or system 600 may reside on a single device (e.g., a computer), or one or more components may reside on separate, discrete devices. Further, each component may be distributed across multiple devices, and one or more of the devices may be interconnected.

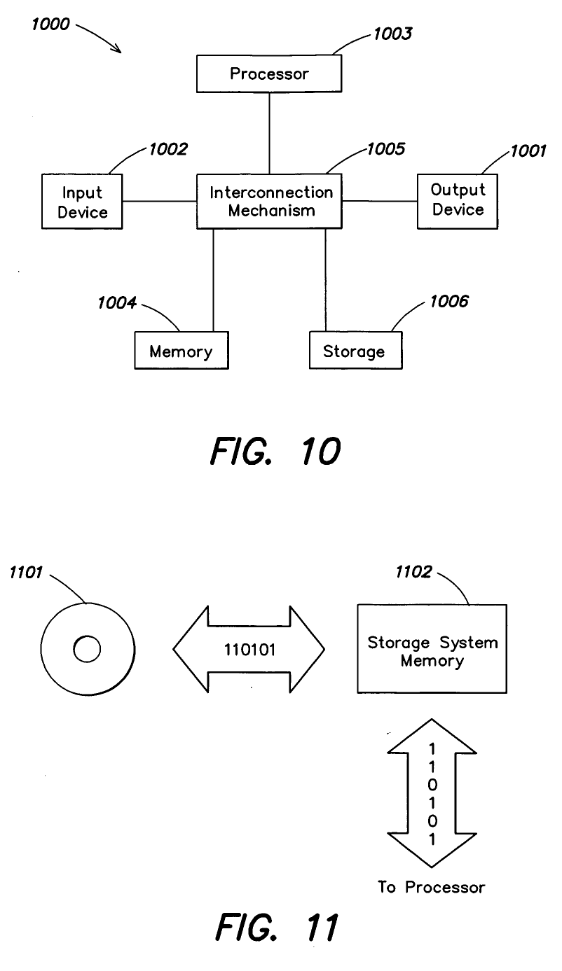

Further, on each of the one or more devices that include one or more components of system 200 and/or system 600, each of the components may reside in one or more locations on the system. For example, different portions of the components of system 200 and/or system 600 may reside in different areas of memory (e.g., RAM, ROM, disk, etc.) on the device. Each of such one or more devices may include, among other components, a plurality of known components such as one, or more processors, a memory system, a disk storage system, one or more network interfaces, and one or more busses or other internal communication links interconnecting the various components. System 200 and/or system 600 and components thereof may be implemented using a computer system such as that described below in relation to FIGS. 10 and 11.

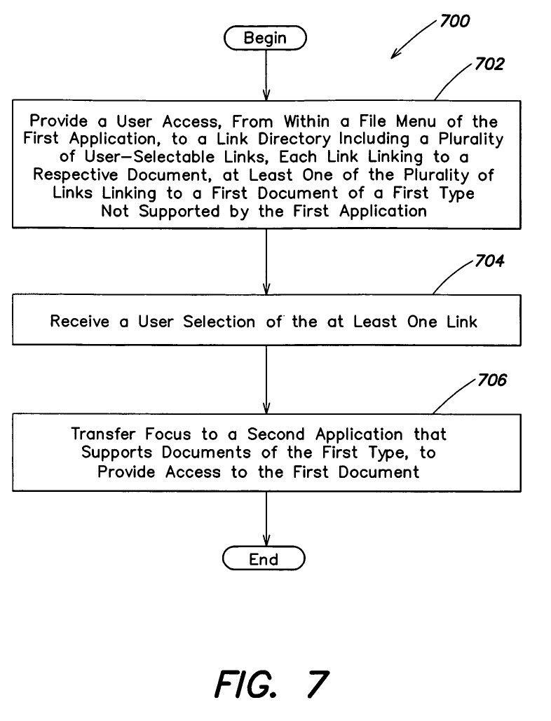

FIG. 7 is a flowchart illustrating an example of a method 700 of providing a user access, from within a first application, to a link directory including a plurality of links to respective documents. Method 700 is merely an illustrative embodiment of a method of providing a user access, from within a first application, to a link directory including a plurality of links to respective documents, and is not intended to limit the scope of the invention. Any of numerous other implementations of such a method, for example, method 800 (described below) and variations of methods 700 and 800, are possible and are intended to fall within the scope of the invention.

In Act 702, a user is provided access, from within a file menu of a first application, to a link directory including a plurality of user-selectable links, each link linking to a respective document. In some embodiments, at least one of the plurality of links points to a first document of a first type not supported by the first application. Act 702 may be implemented by any of the user interfaces described above in relation to FIGS. 2 and 6, using any of the techniques described in relation thereto.

In Act 704, a user selection of a link (e.g., the at least one link) may be received. For example, any of the user interfaces described above may provide user interface display 300 to select a link from a link directory, from which the user selection may be received.

In Act 706, in response to receiving the user selection, focus may be transferred to a second application that supports documents of the first type, thereby providing the user access to the first document. Act 706 may be performed by document linking modules 214 and/or 614 as described above in relation to FIGS. 2 and 6.

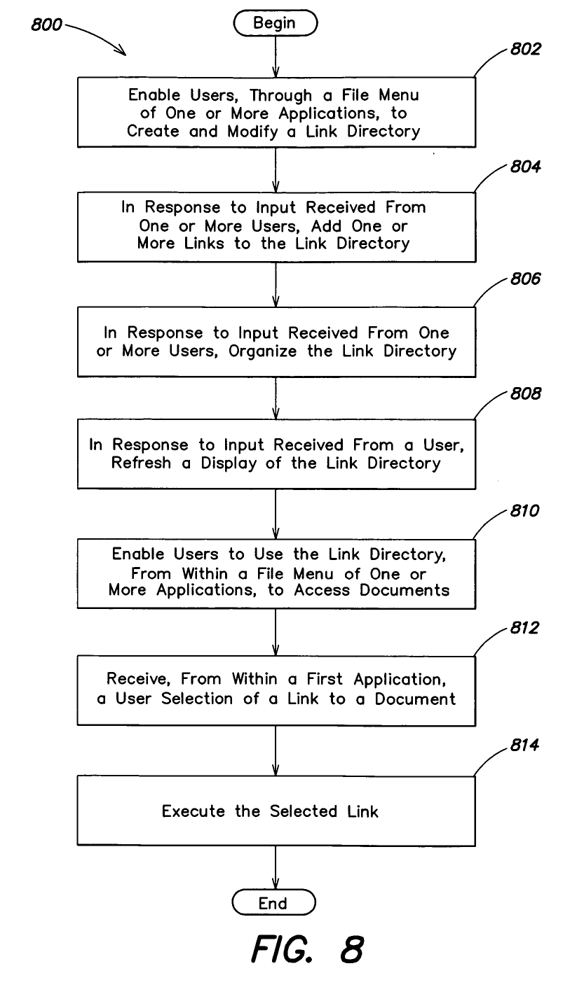

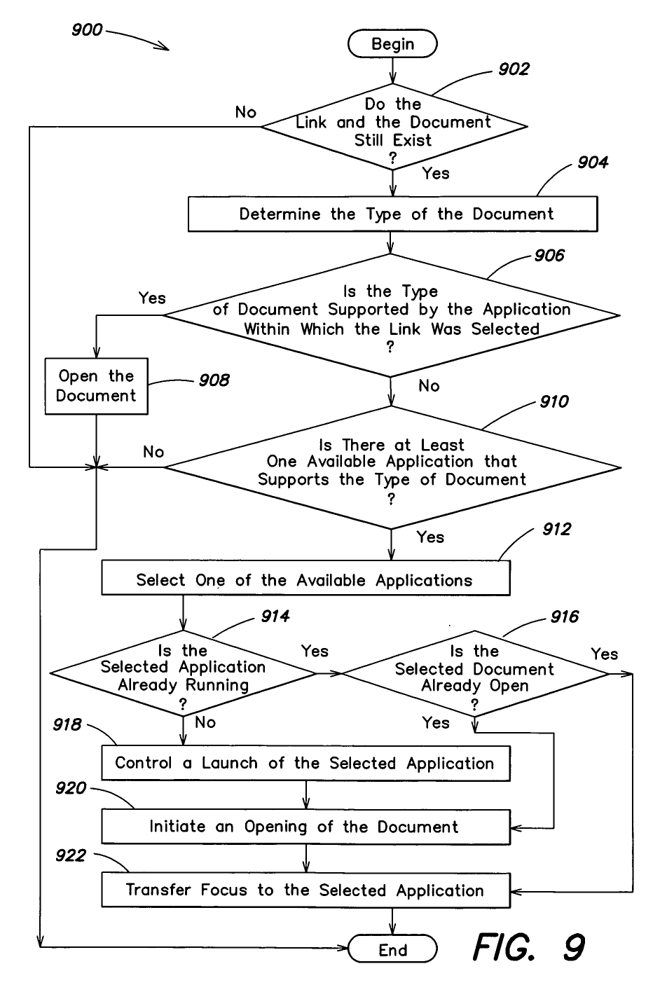

Method 700 may include additional acts such as, for example, one or more of the acts described below in relation to FIGS. 8 and 9. Further, the order of the acts performed as part of method 700 is not limited to the order illustrated in FIG. 7, as the acts may be performed in other orders and/or one or more of the acts may be performed in series or in parallel (at least partially). For example, any of Acts 702-706 may be performed concurrently to the performance of any of these acts by another application (e.g., being executed by another user).

It should be appreciated that method 700 illustrates one example of a method of providing a user access, from within a first application, to one or more documents, where one of the documents is not supported by the first application. The invention is not so limited. In some embodiments of the invention, at least one and possibly all of the documents linked by the link directory are of a type supported by the first application.

FIG. 8 is a flowchart illustrating an example of a method 800 of enabling users, through a file menu of one or more applications, to create, modify and access a link directory. Method 800 is merely an illustrative embodiment of a method of enabling users to create, modify and access a link directory. Any of numerous other implementations of such a method, for example, method 700 and variations of methods 700 and 800, are possible and are intended to fall within the scope of the invention.

In Act 802, users may be enabled to create and modify a link directory through a file menu of one or more applications. For example, a user may be provided, e.g., by one or more of the components of systems 200 and 600 described above, which may provide any of user interface displays 300, 400 and 500 described above in relation to FIGS. 3-5.

In Act 804, in response to input received from one or more users (e.g., through add link component 656), one or more links may be added to the link directory, for example, by link creation module 664. That is, over time, inputs may be received from different users at different times, possibly working from different computers and/or at different locations (e.g., different departments, floors, or even buildings). Each input received may specify to add one or more links to the link directory.

In Act 806, in response to input received from one or more users (e.g., through organized links component 658), the link directory may be organized, for example, by link directory organization module 666. That is, over time, inputs may be received from different users at different times, possibly working from different computers and/or at different locations (e.g., different departments, floors, or even buildings). Each input received may specify one or more instructions for organizing the link directory. Organizing a link directory may include performing any of the functions described above in relation to user interface display 500 shown in FIG. 5.

In Act 808, in response to input received from a user (e.g., through link menu component 654), a display of the link directory may be refreshed, for example, by refresh module 659.

In Act 810, users may be enabled to use the link directory, from within a file menu of one or more applications, to access documents. For example, either of systems 200 and 600 may be configured to provide users access to link directory 218 through one or more user interfaces, which may provide any of user interface displays 300-500.

In Act 812, a user selection of a link to a document may be received from within a first application. For example, link menu component 654 may receive a link selection from a user through link menu 308.

In Act 814, the selected link may be executed, for example, as described above, by link execution module 218 and/or link execution module 618. Act 814 may include performing method 900, described below.

Method 800 may include additional acts to those displayed in FIG. 8. Further, the order of the acts performed as part of method 800 is not limited to the order illustrated in FIG. 8, as the acts may be performed in other orders and/or one or more of the acts may be performed in series or in parallel (at least partially). For example, Acts 804, 806 and 808 may be performed in any order. Further, Acts 802 and 810 may be performed concurrently (e.g., including providing link menu 308 described above), and Acts 810-814 may be performed before any of Acts 802-808.

FIG. 9 is a flowchart illustrating an example of a method 900 for executing a link of a link directory. Method 900 is merely an illustrative embodiment of a method of executing a link, and the invention is not so limited. Any of numerous other implementations of such a method, for example, variations of method 900, are possible and are intended to fall within the scope of the invention. Any of the acts of method 900, described below, may be performed by link execution module 218 and/or link execution module 618.

In Act 902, it is determined whether the link and the document still exist. As described above, a document may have been moved or deleted since a link to the document was created, and a link of a link directory may have been moved or deleted since the link directory was last refreshed.

If it is determined that either the link or the document does not exist, method 900 may end. Further, a message may be displayed to the user indicating that the link or the document does not exist any longer. If the document and link do exist, in Act 904 the type of the document may be determined, for example, by the icon determination module 662.

In Act 906, it may be determined whether the type of document determined in Act 902 is supported by the application from within which the link was selected. If the type of document is supported by the application, then the document may be opened in Act 908. Otherwise, in Act 910 it may be determined whether there is at least one application available to the user that supports the determined type of document.

If no such application is available, then method 900 may end, and an appropriate message may be displayed. Otherwise, in Act 912, one of the available applications may be selected, for example, based on a predefined selection or predefined selection criteria.

In Act 914, it may be determined whether the selected application is already running. If the selected application is already running, then, in Act 916, it may be determined whether the document is already opened. If already opened, then focus may be transferred to the selected application in Act 922. Otherwise, an opening of the document may be initiated in Act 920.

Returning to Act 914, if it is determined that the selected application is not already running, then in Act 918, a launch of the selected application may be controlled, for example, by application launching component 672.

Method 900 may include additional acts. Further, the order of the acts performed as part of method 900 is not limited to the order illustrated in FIG. 9, as the acts may be performed in other orders and/or one or more of the acts may be performed in series or in parallel (at least partially). For example, Act 920 may be performed prior to Act 918 in some circumstances.

Methods 700-900, acts thereof and various embodiments and variations of these methods and acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., methods 700, 800 or 900 or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 200, 600, 1000 and 1100 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to FIGS. 10 and 11, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to convert text to speech and/or edit speech on a portable audio device according to various embodiments of the invention. Further, the software design system may be located on a single computer or may be distributed among a plurality of computers attached by a communications network.

A general-purpose computer system according to one embodiment of the invention is configured to perform convert text to speech and/or edit speech on a portable audio device. It should be appreciated that the system may perform other functions and the invention is not limited to having any particular function or set of functions.

For example, various aspects of the invention may be implemented as specialized software executing in a general-purpose computer system 1000 such as that shown in FIG. 10. The computer system 1000 may include a processor 1003 connected to one or more memory devices 1004, such as a disk drive, memory, or other device for storing data. Memory 1004 is typically used for storing programs and data during operation of the computer system 1000. Components of computer system 1000 may be coupled by an interconnection mechanism 1005, which may include one or more busses (e.g., between components that are integrated within a same machine) and/or a network (e.g., between components that reside on separate discrete machines). The interconnection mechanism 1005 enables communications (e.g., data, instructions) to be exchanged between system components of system 1000. Computer system 1000 also includes one or more input devices 1002, for example, a keyboard, mouse, trackball, microphone, touch screen, and one or more output devices 1001, for example, a printing device, display screen, speaker. In addition, computer system 1000 may contain one or more interfaces (not shown) that connect computer system 1000 to a communication network (in addition or as an alternative to the interconnection mechanism 1005.

The storage system 1006, shown in greater detail in FIG. 11, typically includes a computer readable and writeable nonvolatile recording medium 1101 in which signals are stored that define a program to be executed by the processor or information stored on or in the medium 1101 to be processed by the program. The medium may, for example, be a disk or flash memory. Typically, in operation, the processor causes data to be read from the nonvolatile recording medium 1101 into another memory 1102 that allows for faster access to the information by the processor than does the medium 1101. This memory 1002 is typically a volatile, random access memory such as a dynamic random access memory (DRAM) or static memory (SRAM). It may be located in storage system 1006, as shown, or in memory system 1004, not shown. The processor 1003 generally manipulates the data within the integrated circuit memory 1004, 1102 and then copies the data to the medium 1101 after processing is completed. A variety of mechanisms are known for managing data movement between the medium 1101 and the integrated circuit memory element 1004, 1102, and the invention is not limited thereto. The invention is not limited to a particular memory system 1004 or storage system 1006.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1000 is shown by way of example as one type of computer system upon which various aspects of the invention may be practiced, it should be appreciated that aspects of the invention are not limited to being implemented on the computer system as shown in FIG. 10. Various aspects of the invention may be practiced on one or more computers having a different architecture or components that that shown in FIG. 10.

Computer system 1000 may be a general-purpose computer system that is programmable using a high-level computer programming language. Computer system 1000 may be also implemented using specially programmed, special purpose hardware. In computer system 1000, processor 1003 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from Microsoft Corporation, MAC OS System X available from Apple Computer, the Solaris Operating System available from Sun Microsystems, UNIX available from various sources or Linux available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, J# (J-Sharp) or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for providing a user access, from within a first application, to one or more documents not supported by the first application, the system comprising:
a user interface to provide a user, from within a file menu of the first application, access to a link directory including a plurality of user-selectable links, each link linking to a respective document, at least one of the plurality of links linking to a first document of a first type not supported by the first application; and
a link execution module to transfer focus, in response to a user selecting the first document, to a second application that supports documents of the first type, to provide access to the first document.

2. The system of claim 1, wherein the link execution module is operative to control a launch of the second application in response to the user selecting the first document.

3. The system of claim 1, wherein the first application is member of a Microsoft® Office suite of applications.

4. The system of claim 1, wherein the user interface is operative to control a display, within the file menu, of a menu item for the link directory, wherein the menu item is selectable by a user.

5. The system of claim 1, wherein the user interface is operative to enable a user, through the file menu, to control creation of a link in the link directory.

6. The system of claim 1, wherein at least two of the links link to two documents, respectively, of different type, such that the user interface provides a user access to the at least two documents of different type, and
wherein the user interface is operative to display, for each link in the directory of links, an icon representing a type of the document to which the link links, including displaying at least two different icons corresponding to the at least two links.

7. The system of claim 1, further comprising:
an icon determination module to determine, for each link of the link directory, an icon that represents a type of the document to which the link links.

8. A method of providing a user access, from within a first application, to one or more types of documents not supported by the first application, the method comprising acts of:
(A) providing the user, from within a file menu of the first application, access to a link directory including a plurality of user-selectable links, each link linking to a respective document, at least one of the plurality of links linking to a first document of a first type not supported by the first application; and
(B) in response to the user selecting the first document, transferring focus to a second application that supports documents of the first type, to provide the user access to the first document.

9. The method of claim 8, further comprising an act of:
(C) controlling a launch of the second application.

10. The method of claim 8, wherein the first application is member of a Microsoft® Office suite of applications.

11. The method of claim 8, wherein the Act (A) comprises:
displaying, within the file menu, a menu item for the link directory, wherein the menu item is selectable by a user.

12. The method of claim 8, further comprising:
(C) enabling a user to control, through the file menu, creation of a link in the link directory.

13. The method of claim 8, wherein at least two of the links link to two documents, respectively, of different type, such that the act (A) comprises providing access to the at least two documents of different type, and
wherein the act (A) comprises displaying, for each link in the directory of links, an icon representing a type of the document to which the link links, including displaying at least two distinct icons corresponding to the at least two links.

14. The method of claim 8, further comprising the act of:
(C) determining, for each link of the link directory, an icon that represents a type of the document to which the link links.

15. A computer program product comprising:
a computer-readable medium; and
computer-readable signals, stored on the computer-readable medium, that define instructions that, as a result of being executed by a computer, control the computer to perform a process of providing a user access, from within a first application, to one or more types of documents not supported by the first application, the process comprising acts of:
(A) providing the user, from within a file menu of the first application, access to a link directory including a plurality of user-selectable links, each link linking to a respective document, at least one of the plurality of links linking to a first document of a first type not supported by the first application; and
(B) in response to the user selecting the first document, transferring focus to a second application that supports documents of the first type, to provide the user access to the first document.

16. The computer program product of claim 15, the process further comprising an act of:
(C) controlling a launch of the second application.

17. The computer program product of claim 15, wherein the first application is member of a Microsoft® Office suite of applications.

18. The computer program product of claim 15, wherein the Act (A) comprises:
displaying, within the file menu, a menu item for the link directory, wherein the menu item is selectable by a user.

19. The computer program product of claim 15, further comprising:
(C) enabling a user to control, through the file menu, creation of a link in the link directory.

20. The computer program product of claim 15, further comprising the act of:
(C) determining, for each link of the link directory, an icon that represents a type of the document to which the link links.
